(19) United States
(12) Patent Application Publication
(10) Pub. No.: US 2022/0250591 A1
(43) Pub. Date: Aug. 11, 2022

(54) Vehicle Jacking Assembly

(71) Applicant: Chuol Chuol, Las Vegas, NV (US)

(72) Inventor: Chuol Chuol, Las Vegas, NV (US)

(21) Appl. No.: 17/171,542

(22) Filed: Feb. 9, 2021

(51) Int. Cl. B60S 9/12; B62B 3/10

(52) U.S. Cl. CPC B60S 9/12; B62B 2202/031; B62B 3/104

(57) ABSTRACT

A vehicle jacking assembly includes a plurality of lifting units that is each coupled to a bottom side of a vehicle. Each of the lifting units is actuatable into an extended position to lift a respective tire upwardly from the support surface. A pump is coupled to the vehicle and each of the lifting units is fluidly coupled to the pump. The pump urges a hydraulic fluid into or out of the hydraulic piston of a respective one of the lifting units when the pump is actuated into a lifting condition or a lowering condition. A control is positioned within the vehicle to actuate the pump to urge the hydraulic fluid into a respective one of the lifting units based upon the driver's preference. In this way the respective tire can be lifted from the ground without requiring the driver to manually jack the vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to jacking devices and more particularly pertains to a new jacking device for automatically jacking a vehicle to change a tire. Additionally, a cart is provided for transporting the tire when the tire is removed from the vehicle. The jacking device facilitates the vehicle to be jacked without requiring a driver to manually jack the vehicle.

### (2) Description of Related Art Including Information Disclosed Under 37 CFR 1.97 and 1.98

The prior art relates to jacking devices including a vehicle jacking device that includes pneumatic jacks that are attached to a bottom of a vehicle for jacking the vehicle. The prior art discloses a variety of vehicle jacking device that each includes hydraulic jacks that are attached to a bottom of a vehicle for jacking the vehicle. In no instance does the prior art disclose hydraulic jacks that are mounted to a vehicle and a cart for carrying a tire for the vehicle.

### BRIEF SUMMARY OF THE INVENTION

An embodiment of the disclosure meets the needs presented above by generally comprising a plurality of lifting units that is each coupled to a bottom side of a vehicle. Each of the lifting units is actuatable into an extended position to lift a respective tire upwardly from the support surface. A pump is coupled to the vehicle and each of the lifting units is fluidly coupled to the pump. The pump urges a hydraulic fluid into or out of the hydraulic piston of a respective one of the lifting units when the pump is actuated into a lifting condition or a lowering condition. A control is positioned within the vehicle to actuate the pump to urge the hydraulic fluid into a respective one of the lifting units based upon the driver's preference.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective phantom view of a vehicle jacking assembly according to an embodiment of the disclosure.

FIG. 2 is a perspective in-use view of an embodiment of the disclosure showing a tire on a vehicle being lifted.

FIG. 3 is a perspective view of an embodiment of the disclosure.

FIG. 4 is a cross sectional view taken along line 4-4 of FIG. 3 of an embodiment of the disclosure.

FIG. 5 is a perspective view of a control of an embodiment of the disclosure.

FIG. 6 is a schematic view of an embodiment of the disclosure.

### DETAILED DESCRIPTION OF THE INVENTION

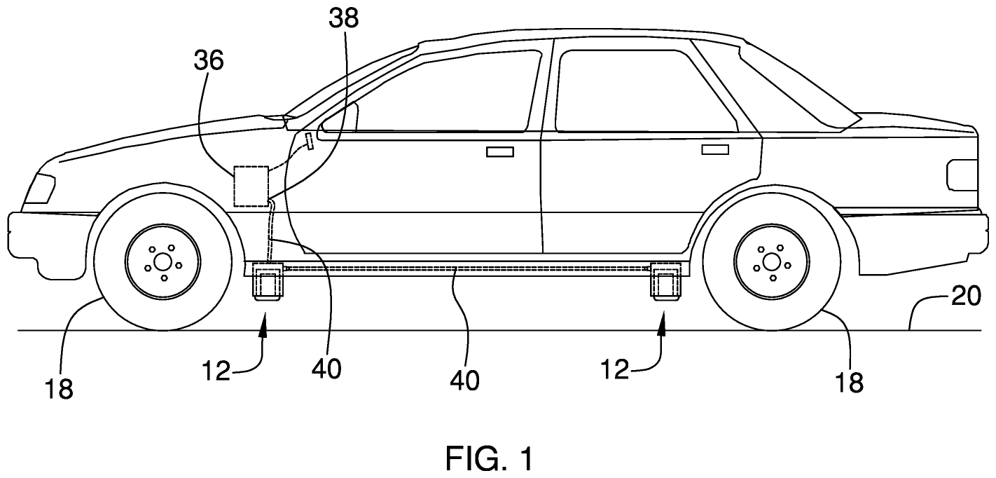

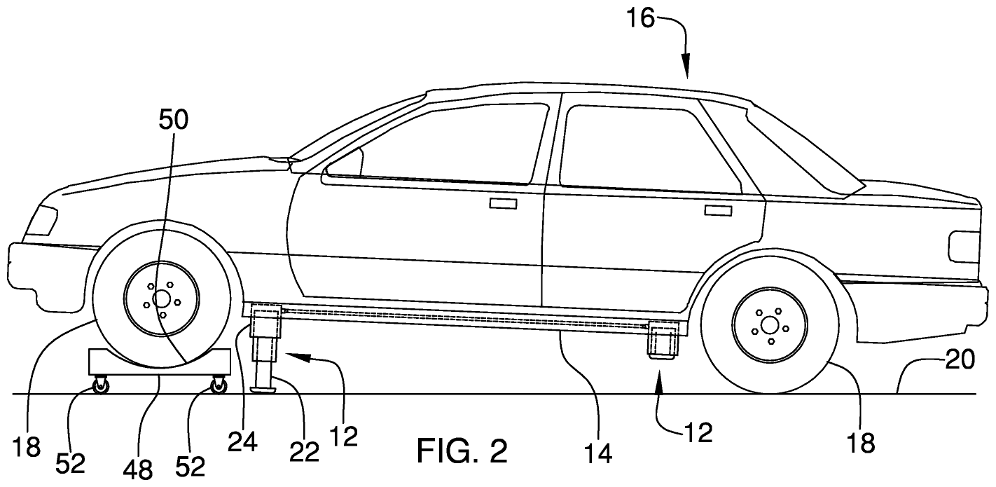

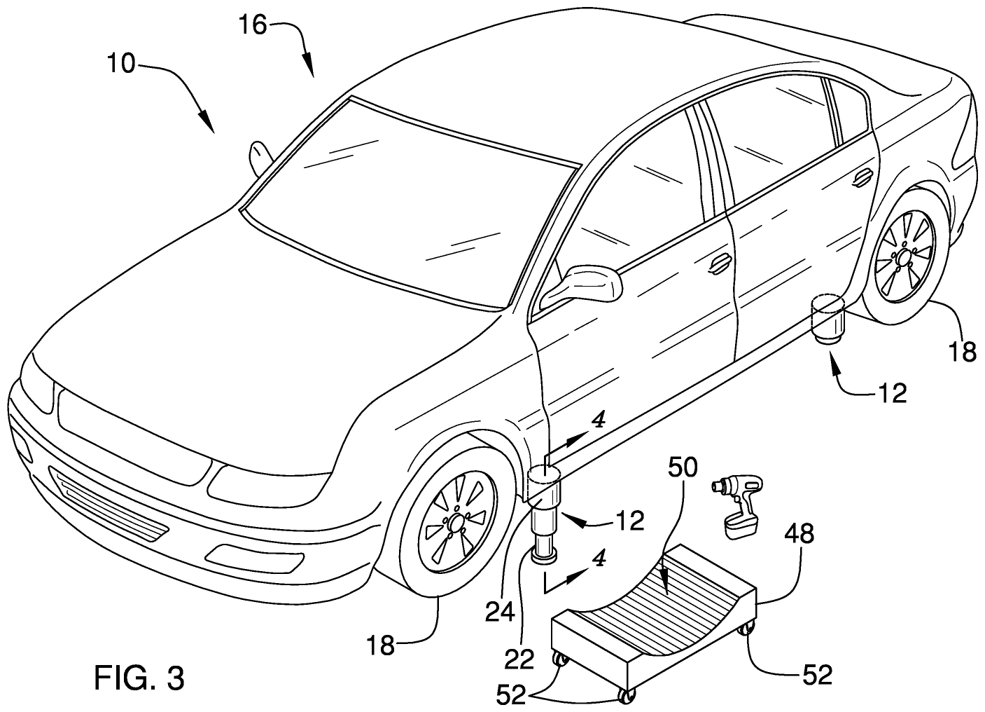

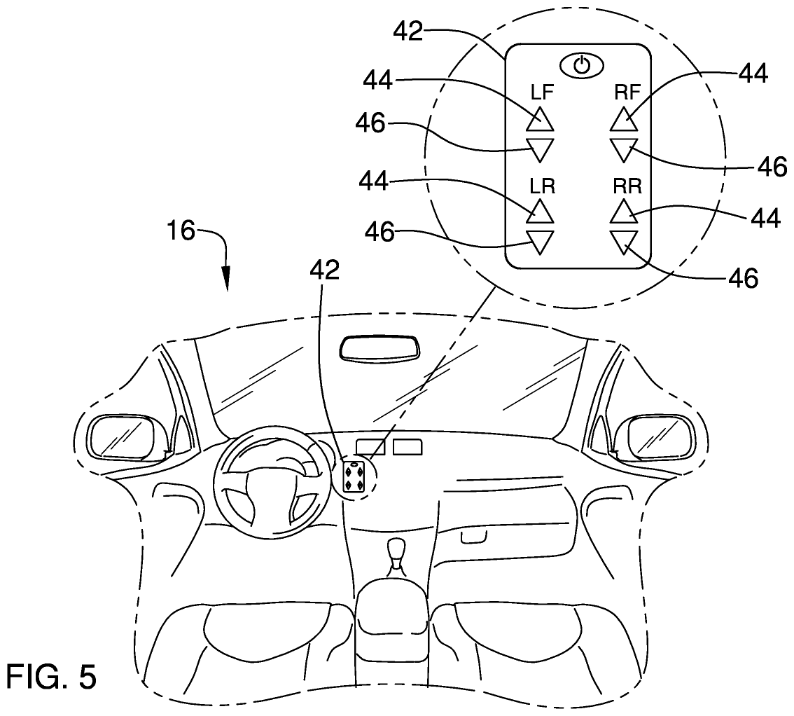

With reference now to the drawings, and in particular to FIGS. 1 through 6 thereof, a new jacking device embodying the principles and concepts of an embodiment of the disclosure and generally designated by the reference numeral 10 will be described.

As best illustrated in FIGS. 1 through 6, the vehicle jacking assembly 10 generally comprises a plurality of lifting units 12 and each of the lifting units 12 is coupled to a bottom side 14 of a vehicle 16. The vehicle 16 may be a passenger vehicle, a cargo vehicle or any other motorized vehicle that is driven on public roadways. Additionally, each of the lifting units 12 is positioned adjacent to a respective one of a plurality of tires 18 on the vehicle 16. Each of the lifting units 12 is actuatable into a retracted position and each of the lifting units 12 is actuatable into an extended position. In this way each of the lifting units 12 engages a support surface 20, such as a roadway or the ground, for lifting the respective tire 18 upwardly from the support surface 20.

Each of the lifting units 12 comprises a hydraulic piston 22 and a housing 24. The housing 24 is coupled to the bottom side 14 of the vehicle 16 and the housing 24 has a lower side 26. The hydraulic piston 22 associated with a respective lifting unit 12 extends downwardly out of the lower side 26 of the housing 24 of the associated lifting unit when the associated lifting unit is actuated into the lowered position. Conversely, the hydraulic piston 22 associated with a respective lifting unit 12 is retracted into the lower side 26 of the housing 24 of the associated lifting unit when the associated lifting unit is actuated into the retracted position.

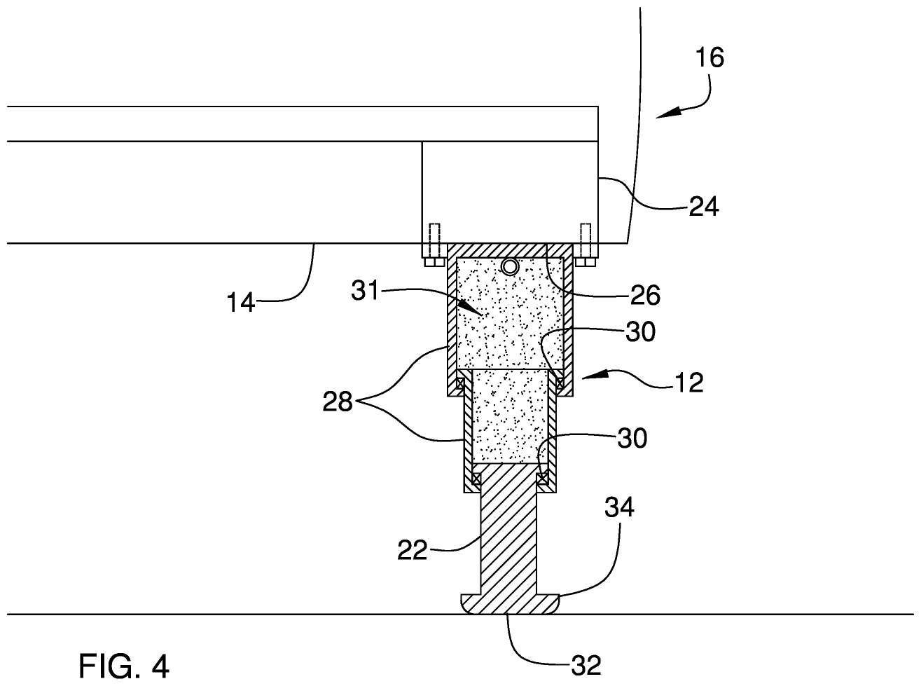

As is most clearly shown in FIG. 4, the hydraulic piston 22 includes a plurality of telescopic sections 28 in which the respective hydraulic piston 22 is slidably positioned. The telescopic sections 28 of a respective hydraulic piston 22 are collapsed into each other when the respective hydraulic piston 22 is retracted. The telescopic sections 28 of a respective hydraulic piston 22 extend outwardly from each other when the respective hydraulic piston 22 is extended. The hydraulic piston 22 includes a plurality of seals 30 that are each positioned between a respective pair of the telescopic sections 28. Each of the seals 30 forms a fluid impermeable seal between the respective pair of telescopic sections 28 to inhibit a hydraulic fluid 31 from leaking from the telescopic sections 28. The hydraulic piston 22 has a distal end 32 and a foot 34 is formed into the distal end 32. The foot 34 abuts the support surface 20 when the hydraulic piston 22 is extended.

A pump 36 is coupled to the vehicle 16 and each of the lifting units 12 is fluidly coupled to the pump 36. The pump 36 urges the hydraulic fluid 31 into the telescopic sections 28 of a respective one of the lifting units 12 when the pump 36 is actuated into a lifting condition. Conversely, the pump 36 urges the hydraulic fluid 31 outwardly from the telescopic sections 28 of a respective one of the lifting units 12 when the pump 36 is actuated into a lowering condition. The pump 36 has a plurality of output ports 38 and the pump 36 urges the hydraulic fluid 31 outwardly from a selected one of the output ports 38 when the pump 36 is turned on. The pump 36 may comprise an electric hydraulic pump or the like. A plurality of conduits 40 is provided and each of the conduits 40 is fluidly coupled between a respective one of the output ports 38 on the pump 36 and the hydraulic piston 22 of a respective one of the lifting units 12. In this way the hydraulic fluid 31 is routed into or out of the hydraulic piston 22 of the lifting units 12.

A control 42 is positioned within the vehicle 16 such that the control 42 is accessible to a driver of the vehicle 16. The control 42 is in communication with the pump 36 and the control 42 actuates the pump 36 to urge the hydraulic fluid 31 into a respective one of the lifting units 12 based upon the driver's preference. The control 42 is electrically coupled to the pump 36 and the control 42 includes a plurality of up buttons 44 and the control 42 includes a plurality of down buttons 46. Each of the up buttons 44 is assigned to a respective one of the output ports 38 on the pump 36, and each of the down buttons 46 is assigned to a respective one of the output ports 38 on the pump 36. The pump 36 urges the hydraulic fluid 31 outwardly through a respective output port 28 unit when the down button 46 assigned to the respective output port 38 is depressed. Conversely, the pump 36 urges the hydraulic fluid 31 inwardly through a respective output port 28 when the up button 44 assigned to the respective output port is depressed. The control 42 is electrically coupled to a power source 47 comprising an electrical system of the vehicle 16.

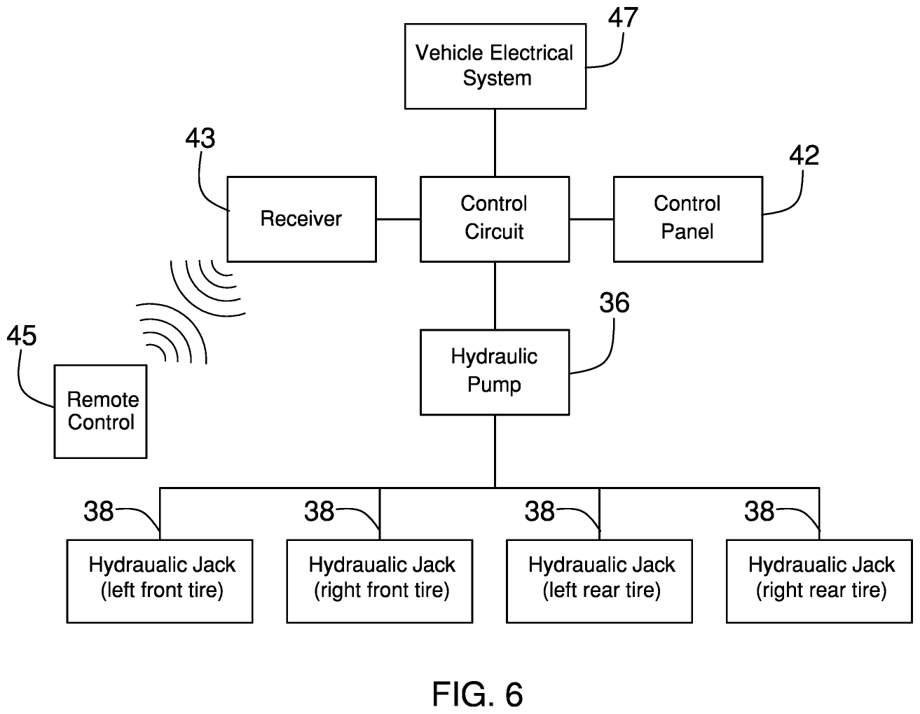

As is most clearly shown in FIG. 6, a receiver 43 may be provided, the receiver 43 may be in electrical communication with the pump 36 and the receiver 43 may comprise a radio frequency receiver or the like. A remote control 45 may be provided and the remote control 45 may be in wireless communication with the receiver 43. In this way each of the lifting units 12 can be remotely controlled. The remote control 45 may include a radio frequency transmitter or the like and the radio frequency transmitter may be in wireless communication with the receiver 43.

A cart 48 is positionable beneath a respective one of the tires 18 on the vehicle 16 when the respective tire 18 is lifted. In this way the cart 48 assists the driver with moving the respective tire 18 when the respective tire 18 is removed from the vehicle 16. The cart 48 has a concavely arcuate depression 50 integrated therein to conform to curvature of the respective tire 18 when the respective tire 18 is positioned in the concavely arcuate depression 50. Additionally, the cart 48 includes a plurality of rollers 52 that each rolls along the support surface 20 for transporting the respective tire 18. The concavely arcuate depression 50 may be textured to inhibit the respective tire 18 from slipping in the concavely arcuate depression 50.

In use, a respective one of the down buttons 46 on the control 42 is depressed to actuate the respective lifting unit 12 into the lowered position. In this way the tire 18 that is positioned adjacent to the respective lifting unit 12 is lifted from the support surface 20 to facilitate the tire 18 to be removed. Additionally, the cart 48 is positioned beneath the tire 18 prior to removing the tire 18. In this way the cart 48 can support the weight of the tire 18 to make transporting the tire 18 easier. The up button 44 that is associated with the respective lifting unit 12 is depressed to actuate the respective lifting unit 12 into the retracted position to lower the vehicle 16 onto the support surface 20. In this way the driver can change any tire 18 on the vehicle 16 without the need to manually jack the vehicle 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle jacking assembly for lifting individual tires on a vehicle off the ground to facilitate the tires to be changed, said assembly comprising:
a plurality of lifting units, each of said lifting units being coupled to a bottom side of a vehicle, each of said lifting units being positioned adjacent to a respective one of a plurality of tires on the vehicle, each of said lifting units being actuatable into a retracted position, each of said lifting units being actuatable into an extended position wherein each of said lifting units is configured to engage a support surface for lifting the respective tire upwardly from the support surface;
a pump being coupled to the vehicle, each of said lifting units being fluidly coupled to said pump, said pump urging a hydraulic fluid into said hydraulic piston of a respective one of said lifting units when said pump is actuated into a lifting condition, said pump urging the hydraulic fluid outwardly from said hydraulic piston of a respective one of said lifting units when said pump is actuated into a lowering condition;
a control being positioned within the vehicle wherein said control is configured to be accessible to a driver of the vehicle, said control being in communication with said pump, said control actuating said pump to urge the hydraulic fluid into a respective one of said lifting units based upon the driver's preference; and
a cart being positionable beneath a respective one of the tires on the vehicle when said respective tire is lifted wherein said cart is configured to assist the driver with moving the respective tire when the respective tire is removed from the vehicle.

2. The assembly according to claim 1, wherein each of said lifting units comprises a hydraulic piston and a housing, said housing being coupled to the bottom side of the vehicle, said housing having a lower side, said hydraulic piston associated with a respective lifting unit extending downwardly out of said lower side of said housing of said associated lifting unit when said associated lifting unit is actuated into said lowered position, said hydraulic piston associated with a respective lifting unit being retracted into said lower side of said housing of said associated lifting unit when said associated lifting unit is actuated into said retracted position.

3. The assembly according to claim 2, wherein said hydraulic piston includes a plurality of telescopic sections, said telescopic sections of a respective hydraulic piston being collapsed into each other when said respective hydraulic piston is retracted, said telescopic sections of a respective hydraulic piston extending outwardly from each other when said respective hydraulic piston is extended.

4. The assembly according to claim 2, wherein:
said pump has a plurality of output ports, said pump urging the hydraulic fluid outwardly from a selected one of said output ports when said pump is turned on; and
a plurality of conduits, each of said conduits being fluidly coupled between a respective one of said output ports on said pump and said hydraulic piston of a respective one of said lifting units for routing the hydraulic fluid into or out of said hydraulic piston of said lifting units.

5. The assembly according to claim 4, wherein said control is electrically coupled to said pump, said control including a plurality of up buttons, said control including a plurality of down buttons, each of said up buttons being assigned to a respective one of said output ports on said pump, each of said down buttons being assigned to a respective one of said output ports on said pump.

6. The assembly according to claim 5, wherein said pump urges the hydraulic fluid outwardly through a respective output port unit when said down button assigned to said respective output port is depressed, said pump urging the hydraulic fluid inwardly through a respective output port unit when said up button assigned to said respective output port is depressed.

7. The assembly according to claim 1, wherein said cart has a concavely arcuate depression being integrated therein wherein said concavely arcuate depression is configured to conform to curvature of the respective tire when the respective tire is positioned in said concavely arcuate depression, said cart including a plurality of rollers each being configured to roll along the support surface for transporting the respective tire.

8. A vehicle jacking assembly for lifting individual tires on a vehicle off the ground to facilitate the tires to be changed, said assembly comprising:
a plurality of lifting units, each of said lifting units being coupled to a bottom side of a vehicle, each of said lifting units being positioned adjacent to a respective one of a plurality of tires on the vehicle, each of said lifting units being actuatable into a retracted position, each of said lifting units being actuatable into an extended position wherein each of said lifting units is configured to engage a support surface for lifting the respective tire upwardly from the support surface, each of said lifting units comprising a hydraulic piston and a housing, said housing being coupled to the bottom side of the vehicle, said housing having a lower side, said hydraulic piston associated with a respective lifting unit extending downwardly out of said lower side of said housing of said associated lifting unit when said associated lifting unit is actuated into said lowered position, said hydraulic piston associated with a respective lifting unit being retracted into said lower side of said housing of said associated lifting unit when said associated lifting unit is actuated into said retracted position, said hydraulic piston including a plurality of telescopic sections, said telescopic sections of a respective hydraulic piston being collapsed into each other when said respective hydraulic piston is retracted, said telescopic sections of a respective hydraulic piston extending outwardly from each other when said respective hydraulic piston is extended;
a pump being coupled to the vehicle, each of said lifting units being fluidly coupled to said pump, said pump urging a hydraulic fluid into said hydraulic piston of an respective one of said lifting units when said pump is actuated into a lifting condition, said pump urging the hydraulic fluid outwardly from said hydraulic piston of a respective one of said lifting units when said pump is actuated into a lowering condition, said pump having a plurality of output ports, said pump urging the hydraulic fluid outwardly from a selected one of said output ports when said pump is turned on;
a plurality of conduits, each of said conduits being fluidly coupled between a respective one of said output ports on said pump and said hydraulic piston of a respective one of said lifting units for routing the hydraulic fluid into or out of said hydraulic piston of said lifting units;
a control being positioned within the vehicle wherein said control is configured to be accessible to a driver of the vehicle, said control being in communication with said pump, said control actuating said pump to urge the hydraulic fluid into a respective one of said lifting units based upon the driver's preference, said control being electrically coupled to said pump, said control including a plurality of up buttons, said control including a plurality of down buttons, each of said up buttons being assigned to a respective one of said output ports on said pump, each of said down buttons being assigned to a respective one of said output ports on said pump, said pump urging the hydraulic fluid outwardly through a respective output port unit when said down button assigned to said respective output port is depressed, said pump urging the hydraulic fluid inwardly through a respective output port unit when said up button assigned to said respective output port is depressed, said control being electrically coupled to a power source comprising an electrical system of the vehicle; and
a cart being positionable beneath a respective one of the tires on the vehicle when the respective tire is lifted wherein said cart is configured to assist the driver with moving the respective tire when the respective tire is removed from the vehicle, said cart having a concavely arcuate depression being integrated therein wherein said concavely arcuate depression is configured to conform to curvature of the respective tire when the respective tire is positioned in said concavely arcuate depression, said cart including a plurality of rollers each being configured to roll along the support surface for transporting the respective tire.

9. A vehicle jacking system for lifting individual tires on a vehicle off the ground to facilitate the tires to be changed, said system comprising:
a vehicle having a bottom side and a plurality of tires;
a plurality of lifting units, each of said lifting units being coupled to said bottom side of said vehicle, each of said lifting units being positioned adjacent to a respective one of said plurality of tires on said vehicle, each of said lifting units being actuatable into a retracted position, each of said lifting units being actuatable into an extended position wherein each of said lifting units is configured to engage a support surface for lifting said respective tire upwardly from the support surface, each of said lifting units comprising a hydraulic piston and a housing, said housing being coupled to said bottom side of said vehicle, said housing having a lower side, said hydraulic piston associated with a respective lifting unit extending downwardly out of said lower side of said housing of said associated lifting unit when said associate lifting unit is actuated into said lowered position, said hydraulic piston associated with a respective lifting unit being retracted into said lower side of said housing of said associated lifting unit when said associate lifting unit is actuated into said retracted position, said hydraulic piston comprising a plurality of telescopic sections, said telescopic sections of a respective hydraulic piston being collapsed into each other when said respective hydraulic piston is retracted, said telescopic sections of a respective hydraulic piston extending outwardly from each other when said respective hydraulic piston is extended;
a pump being coupled to said vehicle, each of said lifting units being fluidly coupled to said pump, said pump urging a hydraulic fluid into said hydraulic piston of an respective one of said lifting units when said pump is actuated into a lifting condition, said pump urging the hydraulic fluid outwardly from said hydraulic piston of a respective one of said lifting units when said pump is actuated into a lowering condition, said pump having a plurality of output ports, said pump urging the hydraulic fluid outwardly from a selected one of said output ports when said pump is turned on;
a plurality of conduits, each of said conduits being fluidly coupled between a respective one of said output ports on said pump and said hydraulic piston of a respective one of said lifting units for routing the hydraulic fluid into or out of said hydraulic piston of said lifting units;
a control being positioned within said a cab of said vehicle wherein said control is configured to be accessible to a driver of the vehicle, said control being in communication with said pump, said control actuating said pump to urge the hydraulic fluid into a respective one of said lifting units based upon the driver's preference, said control being electrically coupled to said pump, said control including a plurality of up buttons, said control including a plurality of down buttons, each of said up buttons being assigned to a respective one of said output ports on said pump, each of said down buttons being assigned to a respective one of said output ports on said pump, said pump urging the hydraulic fluid outwardly through a respective output port unit when said down button assigned to said respective output port is depressed, said pump urging the hydraulic fluid inwardly through a respective output port unit when said up button assigned to said respective output port is depressed, said control being electrically coupled to a power source comprising an electrical system of the vehicle; and
a cart being positionable beneath a respective one of said tires on said vehicle when said respective tire is lifted wherein said cart is configured to assist the driver with moving said respective tire when said respective tire is removed from said vehicle, said cart having a concavely arcuate depression being integrated therein wherein said concavely arcuate depression is configured to conform to curvature of said respective tire when said respective tire is positioned in said concavely arcuate depression, said cart including a plurality of rollers each being configured to roll along the support surface for transporting said respective tire.
